(19) United States
(12) Patent Application Publication
(10) Pub. No.: US 2022/0089464 A1
(43) Pub. Date: Mar. 24, 2022

(54) APPARATUS FOR SIMULTANEOUSLY EXPOSING FLUIDS OR GASES TO A MAGNETIC FIELD AND TO ULTRAVIOLET LIGHT

(71) Applicant: Magnation Corporation, Oakland, CA (US)

(72) Inventors: Michael Jenzeh, Oakland, CA (US); Gerald V. Todd, Bakersfield, CA (US)

(21) Appl. No.: 17/483,671

(22) Filed: Sep. 23, 2021

Related U.S. Application Data
(60) Provisional application No. 63/082,382, filed on Sep. 23, 2020.

(51) Int. Cl. C02F 1/32; C02F 1/48; B01D 53/00; B03C 1/30

(52) U.S. Cl. CPC C02F 1/325; C02F 1/48; C02F 2101/322; B03C 1/30; C02F 2303/04; B01D 53/007

(57) ABSTRACT

An apparatus for simultaneously exposing fluids or gases to a magnetic field and to ultraviolet light includes a tubular body having a fluid inlet, a fluid outlet, an internal passageway, and a lamp-receiving port, the tubular body houses one or more magnets surrounding the internal passageway to provide a magnetic field in the internal passageway along a defined axial length, a UV lamp secured to a lamp-receiving port is disposed in the internal passageway throughout the axial length, a fluid inlet is disposed between the lamp-receiving port and the fluid outlet for introducing flowing fluids, or gases, into the internal passageway for simultaneous exposure to the magnetic field and to UV light generated by the lamp.

### CROSS-REFERENCE TO RELATED APPLICATIONS

This application claims the benefit of U.S. Provisional Application No. 63/082,382 filed Sep. 23, 2020.

### BACKGROUND

### Technical Field

The present invention relates generally to treating fluids and gases and more particularly relates to simultaneous exposure of fluids or gases to magnetic fields and ultraviolet light.

### Description of Related Art

The nature of open bonds favors agglomeration whereby masses of stable compounds form by crystallization or other mechanisms. Perturbation also favors agglomeration by increasing the probability of collision events between micro-particles when electrostatic charging and natural molecular bonding encourage unification of the particles into micro-clumps. The resulting agglomerated particles, sometimes referred to as “hot cross buns” because of their unique appearance as seen in FIG. 1, do not adhere to surfaces, penetrate soils more effectively, and become available as plant nutrients.

FIG. 1 shows particulate CaCO3 in its natural state in a fluid. FIG. 2 shows the effect of agglomeration, resulting in smaller micro-particles, when the fluid is treated by exposure to a magnetic field.

Impact on Mineralization

The flake-like shapes of calcium compounds in intake water, when not broken up through perturbation, exhibit a relatively large surface area-to-mass ratio which can contribute to their accretion into lime scale deposits with which they come into contact.

Larger agglomerated structures, especially those of calcium, in moving water have a lower surface area-to-mass ratio mass such that simple momentum favors their solubility in the water and decreases accretion onto existing deposits. It is believed that their impact helps chip away at existing deposits and is one of the mechanisms for reducing existing limescale deposits in pipes or transitional pores.

Moses Effect

The Moses effect describes the deformation of the surface of certain liquids (including water) by strong magnetic fields and exhibits an interrelationship with surface tension. The impact of strong magnetic fields on the surface tension of water has been demonstrated empirically to last for up to two days.

Large-use field reports consistently demonstrate that standard pumps have a significantly lower power demand, at significant cost savings, when moving magnetically exposed water compared to an equivalent volume of water that has not been treated with strong magnetic fields resulting from reduced surface tension and reduced frictional-coefficient losses attributable to inter-molecular contact of water molecules and contact with pipe surfaces.

Crystallization

Lime scale sediments can form when the dissolved minerals in water become over-concentrated or when their solubility decreases.

The mineral fragmentation within magnetically perturbated water increases the solubility of small particles; in turn, this mechanism allows existing sediments to dissolve back into the passing flow of water.

Interactions of 185 nm Vs. 254 nm UV Light with Water

Two different UV wavelengths are employed in water treatment: 254 nm and 185 nm. The 254 nm (1 nm=10-9 m=10 Å) UV light—also called the germicidal light due to its unique ability to destroy microorganisms—is employed in disinfection and ozone destruction applications. It penetrates the outer cell wall of the microorganism, passes through the cell body, reaches the deoxyribonucleic acid (DNA) and alters the genetic material. The microorganisms thereby are destroyed in a nonchemical manner. The 254 nm UV light also can destroy residual ozone present in a water stream. The 185 nm UV light, utilized in total organic compound reduction application, decomposes the organic molecules. The 185 nm light carries more energy than the 254 nm light. The 185 nm light generates hydroxyl (OH—) free radicals from water molecules and ozone O3 from air or pure oxygen.

Ultraviolet C (UVC) radiation—Invisible rays that are part of the energy that comes from the sun. Most UVC radiation from the sun is blocked from the Earth's surface by the ozone layer. In medicine, UVC radiation may also come from special lamps or a laser and is used to kill germs or to help heal wounds. Ultraviolet technology can be used in water sterilization/disinfection processes. UV irradiation can be used for multiple purposes in water treatment but is primarily employed as a disinfection process that kills water borne pathogens without chemicals.

A major advantage of UVC treatment, properly applied, is that it is capable of disinfecting water faster than chlorine without cumbersome retention tanks and harmful chemicals. UVC treatment systems are also extremely cost efficient over time. Other advantages of treating water with ultraviolet over other disinfection methods include:
Cost—Ultraviolet is cheaper than other methods such as chlorine and ozone.
Ease of Use—There is no need for holding tanks, so there is no danger of tank leakage and treatment is immediate.
Economical—Hundreds of gallons may be treated for each penny of operating cost.
No Chemicals—Ultraviolet irradiation does not use any chemicals or consumables to clean water so there are no harmful bi-products and less waste disposal, which is more environmentally friendly, safer and reduces process time.
Minerals—No beneficial minerals are removed, drinking water stays organic. There is no change in taste, odor, pH or conductivity, nor in the general chemistry of the water. Treatment according to the invention makes water taste “smoother” and neutralizes pH. Neutralizing the pH is a benefit to the pipes that follow the treatment site.
Effectiveness—It is thought that UVC is more effective against viruses than chlorine. The CDC identifies UVC treatment as the only effective method for neutralizing pathogens.

### SUMMARY OF THE INVENTION

A fluid, e.g. water, and gas, e.g., air, treatment device comprises an intense, high flux magnetic field, united with various configurations and frequencies of lamps emitting ultraviolet light installed within or adjacent to a magnetic field through which a flowing medium is to be treated, disinfected or processed.

By treating fluids with a combination of magnetism, ultraviolet light and vortical action, harmful concentrations of microorganisms, volatile organic compounds and other forms of contaminants in a fluid may be remediated in a way not otherwise possible. Decontamination of flowing fluids and gasses from harmful microorganisms and other organic compounds can be performed more efficiently and at lower cost by treating the fluids or gases according to the invention.

### BRIEF DESCRIPTION OF THE DRAWINGS

FIG. 1 is an image of calcium carbonate crystals in a natural state.

FIG. 2 is an image of an agglomeration of calcium carbonate crystals after perturbation.

FIG. 3 is a schematic representation of an apparatus for simultaneously exposing fluids or gases to a magnetic field and to ultraviolet light according to the invention.

FIG. 4 is an end view thereof.

FIG. 5 is a schematic representation of another embodiment thereof.

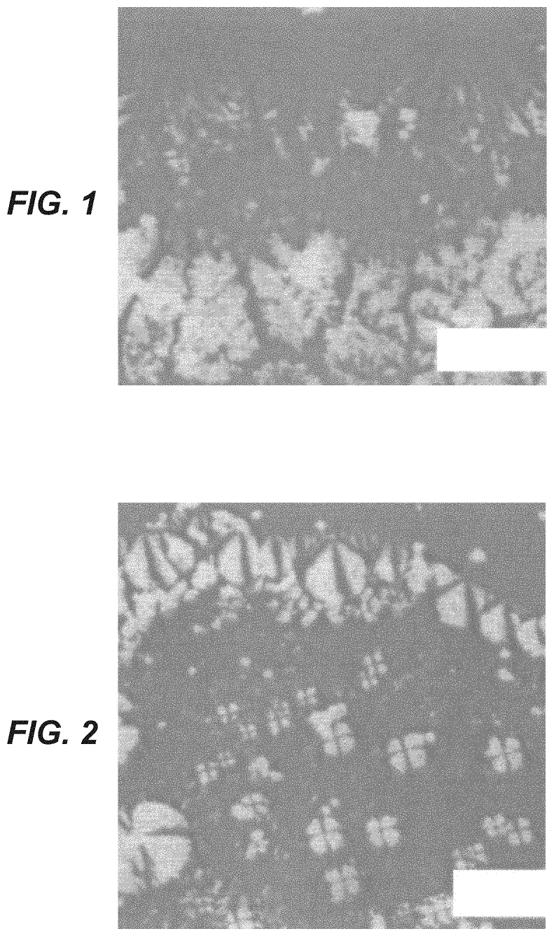

### DETAILED DESCRIPTION OF THE ILLUSTRATED EMBODIMENT

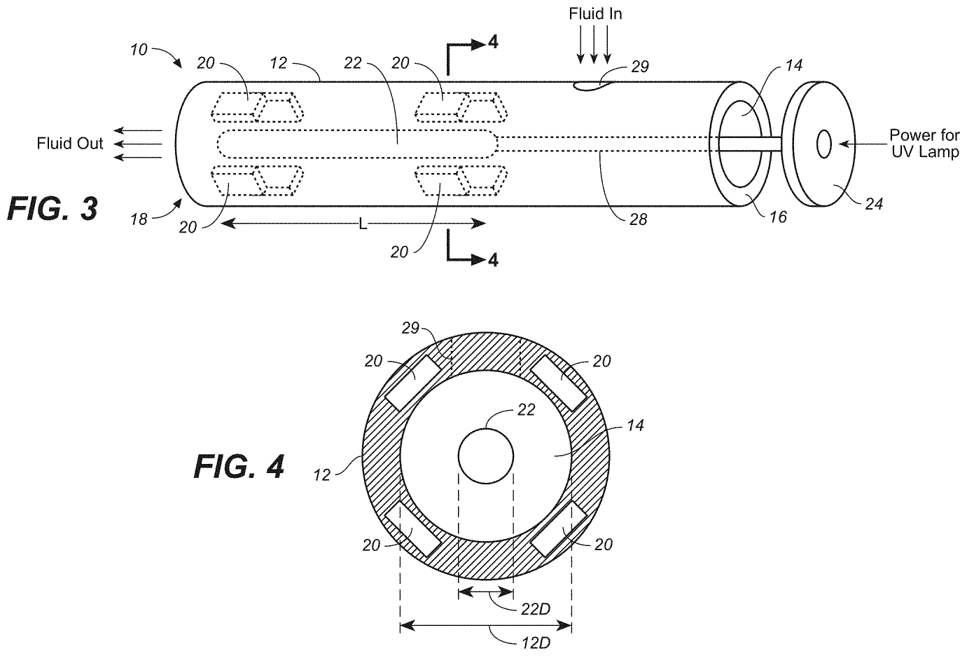

An apparatus for simultaneously exposing fluids or gases to a magnetic field and to ultraviolet light, referred to generally at 10 in FIG. 3, comprises a tubular body 12 having an interior passageway 14 through which fluids or gases can flow, a lamp-receiving port 16 at one end and a fluid outlet 18 at the opposite end.

With additional reference to FIG. 4, it is seen that the body 12 houses one or more magnets 20 surrounding the interior passageway 14 which create a magnetic field that extends into the interior passageway 14 along a defined axial length L thereof.

A UV lamp 22 includes a base 24 for securing the lamp to the lamp-receiving port 16 of the tubular body 12, as seen in FIG. 3, disposing UV lamp 26 in the interior passageway 14 of the tubular body 12. An extension 28 between the base 24 and the lamp 22 positions the lamp 22 so that it is axially coextensive with the axial length L along which the magnets 20 are positioned. The lamp 22 is cylindrical having an outer diameter 22D smaller than the inner diameter 12D of the tubular body 12 allowing fluids to flow in the space between the lamp 22 and the tubular body 12 as best seen in FIG. 4.

In the embodiment shown in FIGS. 3 and 4, the tubular body 12 includes a fluid inlet 29 for introduction of fluids or gases into the interior passageway 14 thereof. Fluids or gases may be guided into the interior passageway 14 by attaching tubes or conduits to the fluid inlet 29 using any mechanism that creates a fluid- or gas-tight connection.

When assembled, fluids or gases introduced into the interior passageway 14 flow along the axial length L of the tubular body 12 where they are exposed to the magnetic fields generated by magnets 20 and simultaneously to UV light emitted by lamp 22.

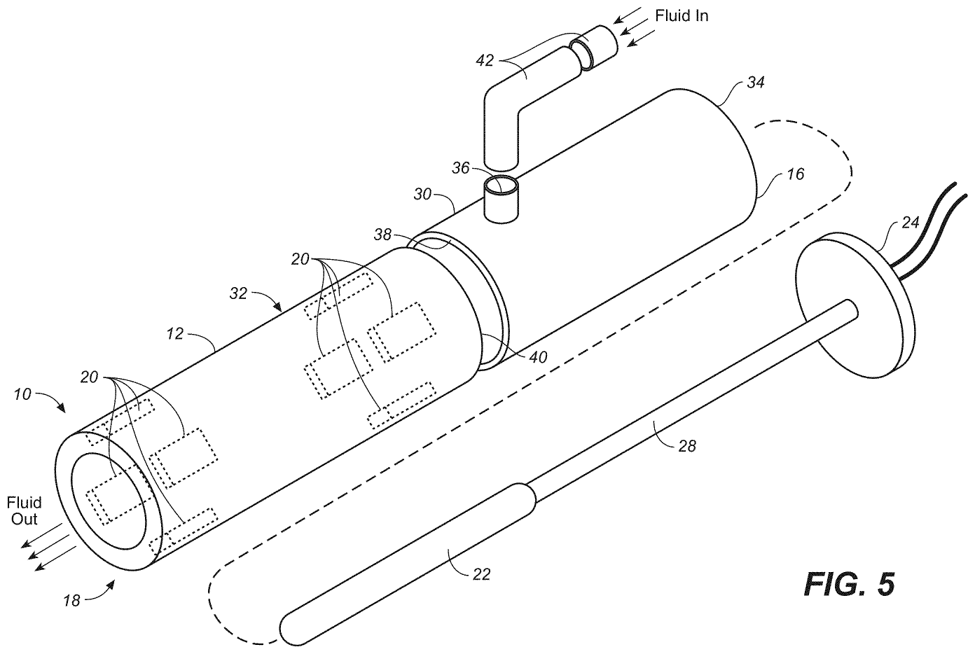

In another embodiment of the invention shown in FIG. 5, a multi-port fitting 30 is attached to a tubular body 32. The multi-port fitting 30 includes a lamp-receiving port 34 and a fluid inlet 36, as in the embodiment shown in FIGS. 3 and 4, as well as a fluid exit port 38 by which fitting 30 may be attached to the fluid entry port 40 of tubular body 32. It will be readily understood that additional tubes or conduits 42 may be attached to fluid inlet 36 to bring to the apparatus the fluids or gases to be treated.

Simultaneous treatment of water using the apparatus described above favors agglomeration of micro-particles increasing their availability as plant nutrients, decreases scaling downstream in pipe systems, and disinfects the water.

There have thus been described and illustrated certain embodiments of an apparatus for simultaneously exposing fluids or gases to a magnetic field and to ultraviolet light according to the invention. Although the present invention has been described and illustrated in detail, it should be clearly understood that the disclosure is illustrative only and is not to be taken as limiting, the spirit and scope of the invention being limited only by the terms of the appended claims and their legal equivalents.

What is claimed is:

1. An apparatus for simultaneously exposing fluids or gases to a magnetic field and to ultraviolet light comprising:
a tubular body having an internal passageway,
the tubular body housing one or more magnets along a defined axial length thereof for establishing a magnetic field that extends into the internal passageway, and
a UV lamp disposed throughout said defined axial length in the passageway,
so that fluids or gases flowing through the internal passageway may be exposed simultaneously to the magnetic field and to UV light emitted from the UV lamp throughout the defined axial length.

2. The apparatus for simultaneously exposing fluids or gases to a magnetic field and to ultraviolet light of claim 1 further comprising:
the tubular body having a fluid inlet, a fluid outlet and a lamp-receiving port, the internal passageway extending between the lamp-receiving port and the fluid outlet, the fluid inlet in communication with the internal passageway between the lamp-receiving port and the fluid outlet.

3. An apparatus for simultaneously exposing fluids or gases to a magnetic field and to ultraviolet light comprising:
a tubular body having a fluid outlet and an internal passageway,
the tubular body housing one or more magnets for establishing a magnetic field that extends into the internal passageway along a defined axial length thereof,
a lamp-receiving port attached to the tubular body and in [linear] communication with the internal passageway, the internal passageway extending between the lamp-receiving port and the fluid exit,
a fluid inlet in communication with the internal passageway between the lamp-receiving port and the fluid exit, and
a UV lamp secured to the lamp-receiving port and disposed in the passageway throughout said defined axial length,
so that fluids or gases flowing through from the fluid inlet to the fluid outlet through the internal passageway may be exposed simultaneously to the magnetic field and to UV light emitted from the UV lamp.

4. The apparatus for simultaneously exposing fluids or gases to a magnetic field and to ultraviolet light of claim 3 further comprising:
the internal passageway of the tubular body having an inside diameter, and
the UV lamp having a cylindrical dimension having an outside diameter smaller than the inside diameter of the internal passageway such that fluids or gases may flow between the UV lamp and the tubular body.

5. The apparatus for simultaneously exposing fluids or gases to a magnetic field and to ultraviolet light of claim 4 further comprising:
the tubular body having a fluid entry port,
a multi-port fitting including the lamp-receiving port, the fluid inlet, and a fluid exit port, the fluid exit port engaged with the fluid entry port of the tubular body, and
the UV lamp secured to the lamp-receiving port of the multi-port fitting.

6. An apparatus for simultaneously exposing fluids or gases to a magnetic field and to ultraviolet light comprising:
a tubular body having a lamp-receiving port, a fluid outlet, and an internal passageway extending between the lamp-receiving port and the fluid outlet,
the tubular body housing one or more magnets along a defined axial length thereof for establishing a magnetic field that extends into the internal passageway,
a UV lamp disposed throughout the defined axial length in the passageway,
the fluid inlet in communication with the internal passageway between the lamp-receiving port and the fluid outlet, so that fluids or gases flowing from the fluid inlet through the internal passageway to the fluid outlet may be exposed simultaneously to the magnetic field and to UV light emitted from the UV lamp.
